(19) United States
(12) Patent Application Publication
(10) Pub. No.: US 2010/0090182 A1
(43) Pub. Date: Apr. 15, 2010

(54) Uv Absorbing Composition

(76) Inventors: Ian Robert Tooley, Cleveland (GB); Robin Riyadh Gibson, County Durham (GB)

Correspondence Address: JONES DAY, 222 EAST 41ST ST, NEW YORK, NY, 10017, US

(21) Appl. No.: 12/308,217

(22) PCT Filed: Jun. 7, 2007
(86) PCT No.: PCT/GB2007/002115

§ 371 Date: Nov. 20, 2009

(30) Foreign Application Priority Data
Jun. 15, 2006 (GB) 0611849.1
Jul. 20, 2006 (GB) 0614405.9

(51) Int. Cl. G02B 5/22

(52) U.S. Cl. 252/589

(57) ABSTRACT

A UV absorbing polymeric composition has an E₃₀₈/E₅₂₄ ratio of greater than 10, and contains an organic resin and titanium dioxide particles. The composition is particularly suitable for use in producing an end-use product, preferably in the form of a polymeric film, exhibiting UV absorbing properties and improved transparency. In one embodiment, the composition may be produced from a masterbatch composition containing an organic resin, an organic dispersing medium and titanium dioxide particles. The masterbatch is preferably prepared by mixing a pre-dispersion of the titanium dioxide particles in the organic dispersing medium, with the organic resin.

### FIELD OF INVENTION

The present invention relates to a UV absorbing polymeric composition, and in particular to one formed using a masterbatch composition comprising an organic resin, an organic dispersing medium and titanium dioxide particles.

### BACKGROUND

Plastics masterbatch compositions are well known. They normally contain an organic resin and pigment suitable for use as pigment concentrate for dilution or “let down” into various non-pigmented plastics or polymeric materials. The masterbatch or pigment concentrate is designed to be diluted into bulk plastics to add opacity and, if necessary, colour or other functionality to the final composition.

Masterbatch techniques are frequently used as a method to incorporate additives such as antiblocks, biocides, heat stabilisers, light stabilisers, pigment and UV absorbers into plastics. Such additives are necessary to overcome physical limitations of plastic materials such as light induced breakdown.

As an alternative to the use of a masterbatch, liquid carrier systems may be used to introduce the aforementioned additives into polymers, e.g. during injection and blow moulding. The additive is pre-dispersed into a liquid carrier usually In the presence of a compatibilising agent, prior to incorporation into the polymeric resin.

Many applications require plastics to be used in exposed conditions, such as outdoors. In these environments, plastics without additive stabilisers will degrade and discolour due to a mixture of heat instability, light instability, weathering (e.g. water ingress) and other chemical attack (e.g. acid rain). Such degradation will have a deleterious effect on both aesthetic and function of the polymer employed. Light stabilisers are a class of additive that are frequently employed to retard the rate of visible and especially UV light induced degradation in non-opaque (semi/transparent or clear) plastics where other protective materials (e.g. pigmentary titanium dioxide) cannot be employed. In applications where a thin cross section of plastic is used, such as films, light stability is often difficult to achieve, as the levels of light stabiliser required often have negative effects on the physical properties of the films either during manufacture or in use. Moreover, the nature of organic light stabiliser compounds is to be chemically stable which can be a negative property when toxicity or biodegradability is considered, especially for biodegradable polymers.

Metal oxides such as titanium dioxide have been employed as attenuators of ultraviolet light in applications such as plastics films and resins, but existing materials either have insufficient UV absorption and/or lack of transparency and/or do not maintain these properties over time.

Consequently, there is a need for a polymeric material that exhibits and maintains both effective UV absorption and transparency, is low or non-toxic in use and/or sufficiently biodegradable.

### SUMMARY OF THE INVENTION

We have now surprisingly discovered an improved polymeric and masterbatch composition, which overcomes or significantly reduces at least one of the aforementioned problems.

Accordingly, the present invention provides a UV absorbing polymeric composition having an E₃₀₈/E₅₂₄ ratio of greater than 10 which comprises an organic resin and titanium dioxide particles.

The invention also provides a masterbatch composition comprising an organic resin, an organic dispersing medium and titanium dioxide particles.

The invention further provides a method of producing a masterbatch composition which comprises mixing a dispersion of titanium dioxide particles in an organic dispersing medium, with an organic resin.

The invention yet further provides a method of producing a UV absorbing polymeric composition having an E₃₀₈/E₅₂₄ ratio of greater than 10 which comprises an organic resin and titanium dioxide particles, comprising the steps of providing (i) a masterbatch composition comprising an organic resin, an organic dispersing medium and titanium dioxide particles, and mixing the masterbatch composition with a substrate organic resin, or (ii) a dispersion of titanium dioxide particles in an organic dispersing medium, and incorporating the dispersion directly into a substrate organic resin.

In one embodiment of the present invention, the UV absorbing polymeric composition may be produced using a masterbatch composition as defined herein.

The organic resin which is present in the masterbatch composition can be any organic resin which is suitable for let-down into plastics or polymeric materials. It may be a thermoplastic resin or a thermosetting resin as will be familiar to the person skilled in the art.

Examples of suitable thermoplastic resins include poly(vinyl chloride) and co-polymers thereof, polyamides and co-polymers thereof, polyolefins and co-polymers thereof, polystyrenes and co-polymers thereof, poly(vinylidene fluoride) and co-polymers thereof, acrylonitrilebutadiene-styrene, polyoxymethylene and acetal derivatives, polybutylene terephthalate and glycolised derivatives, polyethylene terephthalate and glycolised derivatives, polyacrylamide nylon (preferably nylon 11 or 12), polyacrylonitrile and co-polymers thereof, polycarbonate and co-polymers thereof. Polyethylene and polypropylene, which may be modified by grafting of carboxylic acid or anhydride groups onto the polymer backbone, are suitable polyolefins. Low density polyethylene may be used. A poly(vinyl chloride) may be plasticised, and preferably is a homopolymer of vinyl chloride.

Examples of thermosetting resins which may be used are epoxy resins, polyester resins, hybrid epoxy-polyester resins, urethane resins and acrylic resins.

The organic resin is preferably a resin selected or polymerized from the following polymers or monomers that are frequently used for polymeric films either with or without biodegradable qualities; alkyl vinyl alcohols, alkyl vinyl acetates, carbohydrates, casein, collagen, cellulose, cellulose acetate, glycerol, lignin, low density polyethylene, linear low density polyethylene, nylon, polyalkylene esters, polyamides, polyanhydrides, polybutylene adipate/terephthalate, polybutylene succinate, polybutylene succinate/adipate, polycaprolactone, polyesters, polyester carbonate, polyethylene succinate, polyethylene terephthalate, polyglycerol, polyhydroxyalkanoates, polyhydroxy butyrate, polypropylene, polylactates, polysaccharides, polytetramethylene adipate/terephthalate, polyvinyl alcohol polyvinyldiene chloride, proteins, soy protein, triglycerides and variants or co-polymers thereof.

The organic resin preferably has a melting point greater than 40° C., more preferably in the range from 50 to 500° C., particularly 75 to 400° C., and especially 90 to 300° C. The organic resin preferably has a glass transition point (Tg) in the range from −200 to 500° C., more preferably −150 to 400° C., and particularly −125 to 300° C.

The concentration of organic resin is preferably in the range from 20 to 95%, more preferably 30 to 90%, particularly 40 to 80%, and especially 50 to 70% by weight, based upon the total weight of the masterbatch composition.

The titanium dioxide particles used in the present invention may comprise substantially pure titanium dioxide, but are preferably coated.

In one embodiment of the invention the particles have an inorganic coating, preferably an oxide of aluminium, zirconium or silicon, or mixtures thereof such as alumina and silica. The amount of inorganic coating, suitably alumina, is preferably in the range from 2 to 25%, more preferably 4 to 20%, particularly 6 to 15%, and especially 8 to 12% by weight, calculated with respect to the weight of titanium dioxide core particles.

The titanium dioxide used in the present invention is preferably hydrophobic. The hydrophobicity of the titanium dioxide can be determined by pressing a disc of titanium dioxide powder, and measuring the contact angle of a drop of water placed thereon, by standard techniques known in the art. The contact angle of a hydrophobic titanium dioxide is preferably greater than 50°.

The titanium dioxide particles are preferably coated in order to render them hydrophobic. Suitable coating materials are water-repellent, preferably organic, and include fatty acids, preferably fatty acids containing 10 to 20 carbon atoms, such as lauric acid, stearic acid and isostearic acid, salts of the above fatty acids such as sodium salts and aluminium salts, fatty alcohols, such as stearyl alcohol, and silicones such as polydimethylsiloxane and substituted polydimethylsiloxanes, and reactive silicones such as methylhydrosiloxane and polymers and copolymers thereof. Stearic acid and/or salt thereof is particularly preferred. Generally, the particles are treated with up to 25%, suitably in the range from 5 to 20%, more preferably 11 to 16%, particularly 12 to 15%, and especially 13 to 14% by weight of organic material, preferably fatty acid, calculated with respect to the titanium dioxide core particles.

In a preferred embodiment, the titanium dioxide particles are coated with both an inorganic alumina and an organic coating, either sequentially or as a mixture. It is preferred that the alumina is applied first followed by the organic coating, preferably fatty acid and/or salt thereof.

The individual or primary titanium dioxide particles are preferably acicular in shape and have a long axis (maximum dimension or length) and short axis (minimum dimension or width). The third axis of the particles (or depth) is preferably approximately the same dimensions as the width.

The mean length by number of the primary titanium dioxide particles is suitably less than 125 nm, preferably in the range from 50 to 90 nm, more preferably 55 to 77 nm, particularly 60 to 70 nm, and especially 60 to 65 nm. The mean width by number of the particles is suitably less than 25 nm, preferably in the range from 5 to 20 nm, more preferably 10 to 18 nm, particularly 12 to 17 nm, and especially 14 to 16 nm. The primary titanium dioxide particles preferably have a mean aspect ratio d₁:d₂ (where d₁ and d₂, respectively, are the length and width of the particle) in the range from 2.0 to 8.0:1, more preferably 3.0 to 6.5:1, particularly 4.0 to 6.0:1, and especially 4.5 to 5.5:1. The size of the primary particles can be suitably measured using electron microscopy. The size of a particle can be determined by measuring the length and width of a filler particle selected from a photographic image obtained by using a transmission electron microscope.

The primary metal oxide particles suitably have a median volume particle diameter (equivalent spherical diameter corresponding to 50% of the volume of all the particles, read on the cumulative distribution curve relating volume % to the diameter of the particles—often referred to as the “D(v,0.5)” value), measured as herein described, of less than 45 nm, preferably in the range from 25 to 35 nm, more preferably 27 to 33 nm, particularly 28 to 32 nm, and especially 29 to 31 nm.

The titanium dioxide particles suitably have a mean crystal size (measured by X-ray diffraction as herein described) of less than 15 nm, preferably in the range from 4 to 10 nm, more preferably 5 to 9 nm, particularly 6 to 8 nm, and especially 6.5 to 7.5 nm.

The size distribution of the crystal size of the titanium dioxide particles can be important, and suitably at least 30%, preferably at least 40%, more preferably at least 50%, particularly at least 60%, and especially at least 70% by weight of the titanium dioxide particles have a crystal size within one or more of the above preferred ranges for the mean crystal size.

When formed into a dispersion, the particulate titanium dioxide suitably has a median volume particle diameter (equivalent spherical diameter corresponding to 50% of the volume of all the particles, read on the cumulative distribution curve relating volume % to the diameter of the particles—often referred to as the “D(v,0.5)” value)) (hereinafter referred to as dispersion particle size), measured as herein described, of less than 85 nm, preferably in the range from 24 to 50 nm, more preferably 30 to 45 nm, particularly 32 to 40 nm, and especially 34 to 36 nm.

The size distribution of the titanium dioxide particles in dispersion can also be an important parameter in obtaining a masterbatch and UV absorbing polymeric composition having the required properties. In a preferred embodiment suitably less than 10% by volume of titanium dioxide particles have a volume diameter of more than 13 nm, preferably more than 11 nm, more preferably more than 10 nm, particularly more than 9 nm, and especially more than 8 nm below the median volume particle diameter. In addition, suitably less than 16% by volume of titanium dioxide particles have a volume diameter of more than 11 nm, preferably more than 9 nm, more preferably more than 8 nm, particularly more than 7 nm, and especially more than 6 nm below the median volume particle diameter. Further, suitably less than 30% by volume of titanium dioxide particles have a volume diameter of more than 7 nm, preferably more than 6 nm, more preferably more than 5 nm, particularly more than 4 nm, and especially more than 3 nm below the median volume particle diameter.

Also, suitably more than 90% by volume of titanium dioxide particles have a volume diameter of less than 30 nm, preferably less than 27 nm, more preferably less than 25 nm, particularly less than 23 nm, and especially less than 21 nm above the median volume particle diameter. In addition, suitably more than 84% by volume of titanium dioxide particles have a volume diameter of less than 19 nm, preferably less than 18 nm, more preferably less than 17 nm, particularly less than 16 nm, and especially less than 15 nm above the median volume particle diameter. Further, suitably more than 70% by volume of titanium dioxide particles have a volume diameter of less than 8 nm, preferably less than 7 nm, more preferably less than 6 nm, particularly less than 5 nm, and especially less than 4 nm above the median volume particle diameter.

Dispersion particle size of the titanium dioxide particles described herein may be measured by electron microscopy, coulter counter, sedimentation analysis and static or dynamic light scattering. Techniques based on sedimentation analysis are preferred. The median particle size may be determined by plotting a cumulative distribution curve representing the percentage of particle volume below chosen particle sizes and measuring the 50th percentile. The median particle volume diameter and particle size distribution of the titanium dioxide particles in dispersion is suitably measured using a Brookhaven particle sizer, as described herein.

In a particularly preferred embodiment of the invention, the titanium dioxide particles have a BET specific surface area, measured as described herein, of greater than 40, more preferably in the range from 50 to 100, particularly 60 to 90, and especially 65 to 75 m²g⁻¹.

The preferred titanium dioxide particles used in the present invention are transparent, suitably having an extinction coefficient at 524 nm (E₅₂₄), measured as described herein, of less than 2.0, preferably in the range from 0.3 to 1.5, more preferably 0.4 to 1.2, particularly 0.5 to 1.0, and especially 0.6 to 0.91/g/cm. In addition, the titanium dioxide particles suitably have an extinction coefficient at 450 nm (E₄₅₀, measured as described herein, in the range from 0.8 to 2.2, preferably 1.0 to 2.0, more preferably 1.2 to 1.8, particularly 1.3 to 1.7, and especially 1.4 to 1.6 l/g/cm.

The titanium dioxide particles exhibit effective UV absorption, suitably having an extinction coefficient at 360 nm (E₃₆₀), measured as described herein, in the range from 2 to 14, preferably 4 to 11, more preferably 5 to 9, particularly 6 to 8, and especially 6.5 to 7.5 μg/cm. The titanium dioxide particles also suitably have an extinction coefficient at 308 nm (E₃₀₈), measured as described herein, in the range from 38 to 55, preferably 40 to 52, more preferably 42 to 50, particularly 44 to 48, and especially 45 to 47 l/g/cm.

The titanium dioxide particles suitably have a maximum extinction coefficient E(max), measured as described herein, in the range from 50 to 70, preferably 53 to 67, more preferably 56 to 64, particularly 58 to 62, and especially 59 to 61 l/g/cm. The titanium dioxide particles suitably have a λ(max), measured as described herein, in the range from 270 to 292, preferably 274 to 288, more preferably 277 to 285, particularly 279 to 283, and especially 280 to 282 nm.

The titanium dioxide particles suitably have an E₃₀₈/E₅₂₄ ratio of greater than 20, preferably greater than 40, more preferably in the range from 45 to 85, particularly 50 to 75, and especially 55 to 65.

The titanium dioxide particles suitably exhibit reduced whiteness, having a change in whiteness ΔL of a dispersion containing the particles, measured as herein described, of less than 7, preferably in the range from 1 to 6, more preferably 2 to 5, and particularly 3 to 4. In addition, the titanium dioxide particles preferably have a whiteness index, measured as herein described, of less than 100%, more preferably in the range from 20 to 80%, particularly 30 to 70%, and especially 40 to 60%.

The titanium dioxide particles preferably have significantly reduced photoactivity, suitably having a photogreying index, measured as herein described, of less than 7, preferably in the range from 0.1 to 5, more preferably 0.3 to 3, particularly 0.5 to 2, and especially 0.7 to 1.

Photogreying is an indirect measure of the quality of the coating layer on the titanium dioxide core particles, and lower values indicate improved coating coverage such as more complete surface coverage, increased thickness and/or greater density of the coating layer.

The concentration of titanium dioxide particles in a masterbatch composition according to the present invention is preferably in the range from 1 to 50%, more preferably 5 to 40%, particularly 10 to 30%, and especially 12 to 20% by weight, based upon the total weight of the masterbatch composition.

The titanium dioxide particles are preferably dispersed in the organic dispersing medium. The organic dispersing medium preferably has a melting point lower than the melting point, more preferably lower than the glass transition temperature (Tg), of the organic resin in the masterbatch composition.

The organic dispersing medium preferably has a melting point of less than 400° C., more preferably less than 300° C., particularly less than 270° C., and especially less than 250° C. The dispersing medium is preferably liquid at ambient temperature (25° C.).

Suitable dispersing media include non-polar materials such as C13-14 isoparaffin, isohexadecane, paraffinum liquidum (mineral oil), squalane, squalene, hydrogenated polyisobutene, polydecene; silicone oils and polar materials such as C12-15 alkyl benzoate, cetearyl isononanoate, ethylhexyl isostearate, ethylhexyl palmitate, isononyl isononanoate, isopropyl isostearate, isopropyl myristate, isostearyl isostearate, isostearyl neopentanoate, octyldodecanol, pentaerythrityl tetraisostearate, PPG-15 stearyl ether, triethylhexyl triglyceride, dicaprylyl carbonate, ethylhexyl stearate, helianthus annus (sunflower) seed oil, isopropyl palmitate, octyldodecyl neopentanoate, glycerol monoester (C4 to C24 fatty acid, e.g. glycerol monostearate, glycerol monoisostearate), glycerol diester (C4 to C24 fatty acid), glycerol triester or triglyceride (C4 to C24 fatty acid, e.g. caprylic/capric triglyceride or Estol 1527), ethylene bis-amide (C4 to C24 fatty acid, e.g. ethylene bis-stearamide), C4 to C24 fatty acid amide (e.g. erucamide), polyglyercol ester (C4 to C24 fatty acid) and organosilicones. Preferably the dispersing medium is selected from the group consisting of glycerol esters, glycerol ethers, glycol esters, glycerol ethers, alkyl amides, alkanolamines, and mixtures thereof. More preferably, the dispersing medium is glycerol monostearate, glycerol monoisostearate, diethanolamine, stearamide, oleamide, erucamide, behenamide, ethylene bis-stearamide, ethylene bis-isostearamide, polyglycerol stearate, polyglycerol isostearate, polyglycol ether, triglyceride, or mixtures thereof.

The concentration of organic dispersing medium in a masterbatch composition according to the present invention is preferably in the range from 1 to 50%, more preferably 5 to 40%, particularly 12 to 30%, and especially 15 to 25% by weight, based upon the total weight of the masterbatch composition.

In a preferred embodiment of the present invention, the particulate titanium dioxide is formed into a slurry, more preferably a liquid dispersion, in the aforementioned suitable organic dispersing medium. This pre-dispersion can then be mixed with the aforementioned organic resin.

By liquid dispersion is meant a true dispersion, i.e. where the solid particles are stable to aggregation. The particles in the dispersion are relatively uniformly dispersed and resistant to settling out on standing, but if some settling out does occur, the particles can be easily redispersed by simple agitation.

The dispersion may also contain a dispersing agent in order to improve the properties thereof. The dispersing agent is suitably present in the range from 1 to 30%, preferably 2 to 20%, more preferably 9 to 20%, particularly 11 to 17%, and especially 13 to 15% by weight based on the total weight of titanium dioxide particles.

Suitable dispersing agents include substituted carboxylic acids, soap bases and polyhydroxy acids. Typically the dispersing agent can be one having a formula X.CO.AR in which A is a divalent bridging group, R is a primary secondary or tertiary amino group or a salt thereof with an acid or a quaternary ammonium salt group and X is the residue of a polyester chain which together with the —CO— group is derived from a hydroxy carboxylic acid of the formula HO—R′—COON. As examples of typical dispersing agents are those based on ricinoleic acid, hydroxystearic acid, hydrogenated castor oil fatty acid which contains in addition to 12-hydroxystearic acid small amounts of stearic acid and palmitic acid. Dispersing agents based on one or more polyesters or salts of a hydroxycarboxylic acid and a carboxylic acid free of hydroxy groups can also be used. Compounds of various molecular weights can be used.

Other suitable dispersing agents are those monoesters of fatty acid alkanolamides and carboxylic acids and their salts. Alkanolamides are based on ethanolamine, propanolamine or aminoethyl ethanolamine for example. Alternative dispersing agents are those based on polymers or copolymers of acrylic or methacrylic acids, e.g. block copolymers of such monomers. Other dispersing agents of similar general form are those having epoxy groups in the constituent radicals such as those based on the ethoxylated phosphate esters. The dispersing agent can be one of those commercially referred to as a hyper dispersant. Polyhydroxystearic acid is a particularly preferred dispersing agent.

The dispersions used in the present invention suitably contain at least 35%, preferably at least 40%, more preferably at least 45%, particularly at least 50%, especially at least 55%, and generally up to 60% by weight of the total weight of the dispersion, of titanium dioxide particles.

The concentration of titanium dioxide dispersion in a masterbatch composition according to the present invention is preferably in the range from 5 to 80%, more preferably 10 to 70%, particularly 20 to 60%, and especially 30 to 50% by weight, based upon the total weight of the masterbatch composition.

The masterbatch and UV absorbing polymeric composition according to the present invention may further contain other additional components often used in such compositions, such as pigments, dyes, catalysts and curing accelerators, flow control additives, antifoaming, matting agents, antioxidants, antislip, and in particular other UV absorbing agents.

The masterbatch and UV absorbing polymeric composition may contain titanium dioxide particles described herein as the sole UV absorbing agent, or the titanium dioxide particles may be used together with other UV absorbing agents such as other metal oxides and/or organics and/or organometallic complexes. For example, the titanium dioxide particles may be used in combination with other existing commercially available titanium dioxide and/or zinc oxide particles.

The titanium dioxide particles and dispersions described herein may be used in binary, tertiary or further multiple combinations with organic UV absorbers such as benzophenones, benzotriazoles, triazines, hindered benzoates, hindered amines (HALS) or co-ordinated organo-nickel complexes. Examples of such organic UV absorbing materials include 2-hydroxy-4-n-butyloctylbenzophenone, 2-hydroxy-4-methoxybenzophenone, 2-(2′-hydroxy-3′,5′-di-t-amylphenyl)benzotriazole, 2-(2′-hydroxy-3′,5′-di(1,1-dimethylbenzyl))-2H-benzotriazole, bis(2,2,6,6-tetramethyl-4-piperidenyl) sebacate and [2,2′-thiobis(4-t-octylphenolate)] N-butylamine-nickel.

The concentration of organic UV absorber in a masterbatch composition is preferably in the range from 0.1 to 50%, more preferably 1 to 40%, particularly 5 to 30%, and especially 10 to 20% by weight, based upon the total weight of the masterbatch composition.

It is generally necessary to intimately mix the ingredients of the masterbatch composition of the invention in order to achieve a satisfactorily homogeneous finished concentrate. Commonly used methods of producing an intimate mixture include melt-mixing and dry blending.

In the melt-mixing process, dry ingredients (e.g. organic resin, and other additives) are weighed into a batch mixer such as a high intensity impeller mixer, a medium intensity plough-share mixer or a tumble mixer. Mixing times depend upon the equipment used. For high intensity mixers, the mixing time is usually in the range 1 to 5 minutes and the mixing time in a tumble mixer is frequently in the range 30 to 60 minutes. The premix thus formed is then compounded together with liquid ingredients (e.g. titanium dioxide dispersion) In a high shear extruder such as a single screw extruder (e.g. Buss Ko-kneader [RTM]) or a twin screw extruder. It is particularly important to ensure that the combination of temperature of the mixture and residence time for thermosetting compositions is such that little or no curing takes place in the extruder, although the temperature is usually slightly above the melting point of the organic resin. The appropriate processing temperature is chosen to suit the resin present in the composition, but is usually in the range 60 to 300° C.

Residence time in the extruder is usually in the range from 0.5 to 2 minutes. The resultant mixture is then typically extruded through a strand die. The extruded material is usually cooled rapidly by water cooling, such as in a water trough, and broken into pellets or chips with a size of about 5 to 10 mm. These pellets or chips can then be dried and ground further to an appropriate particle size using conventional techniques as necessary. Frequently, thermoplastic resins need to be ground using cryogenic techniques.

Masterbatch compositions can also be prepared by dry blending, and this technique is particularly suitable where the organic resin is plasticised poly(vinyl chloride). All of the ingredients are agitated in a high speed mixer at an elevated temperature in order to achieve intimate mixing.

It is desirable that the masterbatch produced according to the invention is free of holes or voids resulting from incorporation of moisture or volatiles in the masterbatch during compounding. Methods of prevention of such (venting of compounding extruder barrels via vacuum etc) are well known in the art.

The masterbatch composition according to the present invention suitably has an extinction coefficient at 524 nm (E₅₂₄), measured as described herein, of less than 2.0, preferably in the range from 0.3 to 1.5, more preferably 0.4 to 1.2, particularly 0.5 to 1.0, and especially 0.6 to 0.91/g/cm.

The masterbatch composition exhibits effective UV absorption, suitably having an extinction coefficient at 308 nm (E₃₀₈), measured as described herein, of greater than 20, preferably in the range from 25 to 55, more preferably 30 to 50, particularly 35 to 45, and especially 37 to 43 l/g/cm.

In a particularly preferred embodiment of the present invention, the masterbatch composition suitably has an E₃₀₈/E₅₂₄ ratio of greater than 10, preferably greater than 20, more preferably greater than 30, particularly greater than 40, and especially in the range from 50 to 70.

A surprising feature of the present invention is that a masterbatch composition containing titanium dioxide particles can be produced having an E₃₀₈/E₅₂₄ ratio suitably at least 45%, preferably at least 55%, more preferably at least 65%, particularly at least 75%, and especially at least 85% of the original value for the titanium dioxide particles (measured as described herein (in dispersion)).

The masterbatch composition according to the invention is suitable for let down into a substrate resin using any method normally used for pigmenting substrates with masterbatches. The precise nature of the substrate or second organic resin will often determine the optimum conditions for application. The appropriate temperature for let down and application depends principally upon the actual resin or resins used, and is readily determined by a person skilled in the art. The substrate resin may be a thermoplastic or thermoset resin. Suitable substrate resins in which masterbatches are used include poly(vinyl chloride) and co-polymers thereof, polyamides and co-polymers thereof, polyolefins and co-polymers thereof, polystyrenes and co-polymers thereof, poly(vinylidene fluoride) and co-polymers thereof, acrylonitrile-butadiene-styrene, polyoxymethylene and acetal derivatives, polybutylene terephthalate and glycolised derivatives, polyethylene terephthalate and glycolised derivatives, polyacrylamide nylon (preferable nylon 11 or 12), polyacrylonitrile and co-polymers thereof, polycarbonate and co-polymers thereof. Polyethylene and polypropylene, which may be modified by grafting a carboxylic acid or anhydride groups onto the polymer backbone, are suitable polyolefins. Low density polyethylene may be used. A poly(vinyl chloride) may be plasticised, and preferably is a homopolymer of vinyl chloride.

The substrate or second organic resin is preferably a resin selected or polymerized from the following polymers or monomers that are frequently used for polymeric films either with or without biodegradable qualities; alkyl vinyl alcohols, alkyl vinyl acetates, carbohydrates, casein, collagen, cellulose, cellulose acetate, glycerol, lignin, low density polyethylene, linear low density polyethylene, nylon, potyalkylene esters, polyamides, polyanhydrides, polybutylene adipate/terephthalate, polybutylene succinate, polybutylene succinate/adipate, polycaprolactone, polyesters, polyester carbonate, polyethylene succinate, polyethylene terephthalate, polyglycerol, polyhydroxyalkanoates, polyhydroxy butyrate, polypropylene, polylactates, polysaccharides, polytetramethylene adipate/terephthalate, polyvinyl alcohol polyvinyldiene chloride, proteins, soy protein, triglycerides and variants or co-polymers thereof.

Let down of the masterbatch composition to give the desired titanium dioxide concentration in the final application may be achieved by tumble mixing the masterbatch composition with a quantity of a compatible diluent substrate resin. The mixture is then fed to a single or twin-screw compounding extruder and processed as described earlier (in the context of the preparation of a masterbatch composition) to produce a fully compounded resin with additives present at the concentrations required in the final application or is fed to a profile or sheet extrusion, blown or cast polymer foil or film unit for conversion Into the desired product form.

Alternatively the masterbatch and compatible diluent substrate resin can be fed by an automatic metering system of a type common within the industry to a single or twin-screw compounding extruder and processed as described earlier to produce a fully compounded resin with additives present at the concentrations required in the final application; or is fed to a profile or sheet extrusion, blown or cast polymer foil or film unit for conversion into the desired product form.

Generally, the first organic resin (used in the masterbatch) is the same as the substrate resin (let down). However, this is not necessarily the case, and it is possible that the first organic resin may be different to the substrate or second organic resin.

Data obtained by an analysis of a successfully let down masterbatch containing the titanium dioxide particles described here show values for transmittance, haze, clarity, L*, a*, b* as well as other physical (e.g. gloss 60° and 20°, mechanical and toxicological characteristics that are either sufficiently similar to the polymer not containing the masterbatches described here or of sufficient value in their own right as to be commercially applicable. Typical masterbatch formulations are developed so as to be manufactured by an economical route, thus It is desirable that the use of additives provided by the present invention affects such processes as little as possible. This is typically assessed by measuring the power consumption of blender/extruder unit and production rate.

The application of the masterbatch in the let-down of a plastic needs to produce material that is neither economically deleterious to processing efficiency or quality of the final product. The quality of the let down product is measured as for the masterbatch itself (opacity, L*, a*, b*, gloss (60 and 20) and other mechanical data). The efficiency of the manufacture of the let down product is measured as per masterbatch formulation (power consumption and rate).

In an alternative embodiment of the present invention, the UV absorbing polymeric composition may be produced using a titanium dioxide dispersion as defined herein as a liquid carrier system. Liquid carrier systems are normally used in injection and blow moulding, but they can also be applied to the manufacture of polymeric film and fibre.

The pre-dispersion can be pumped using a peristaltic, gear or other suitable pump into the extruder section of the process, where it is directly injected into the polymeric resin. Suitable polymeric resins include any one or more of the substrate or second organic resins described herein.

The final or end-use UV absorbing polymeric composition, for example in the form of a polymeric film, according to the present invention suitably has an extinction coefficient at 524 nm (E₅₂₄), measured as described herein, of less than 2.0, preferably in the range from 0.3 to 1.5, more preferably 0.4 to 1.2, particularly 0.5 to 1.0, and especially 0.6 to 0.9 l/g/cm.

The UV absorbing polymeric composition, for example in the form of a polymeric film, exhibits effective UV absorption, suitably having an extinction coefficient at 308 nm (E₃₀₈), measured as described herein, of greater than 20, preferably in the range from 25 to 55, more preferably 30 to 50, particularly 35 to 45, and especially 37 to 43 l/g/cm.

The UV absorbing polymeric composition, for example in the form of a polymeric film, has an E₃₀₈/E₅₂₄ ratio of greater than 10, preferably greater than 20, more preferably greater than 30, particularly greater than 40, and especially in the range from 50 to 70.

A surprising feature of the present invention is that a UV absorbing polymeric composition, for example in the form of a polymeric film, can be produced having an E₃₀₈/E₅₂₄ ratio suitably at least 45%, preferably at least 55%, more preferably at least 65%, particularly at least 75%, and especially at least 85% of the original value for the titanium dioxide particles (measured as described herein (in dispersion)).

In one embodiment, the final or end-use UV absorbing polymeric composition, for example in the form of a polymeric film, suitably comprises (I) 60 to 99.9%, preferably 80 to 99.7%, more preferably 90 to 99.6%, and particularly 98 to 99.5% by weight of organic resin; (ii) 0.05 to 20%, preferably 0.1 to 10%, more preferably 0.2 to 5%, and particularly 0.3 to 2% by weight of organic dispersing medium; and (iii) 0.05 to 20%, preferably 0.1 to 10%, more preferably 0.2 to 5%, and particularly 0.25 to 2% by weight of titanium dioxide particles.

The UV absorbing polymeric composition of the present invention can be used in many applications, such as plastic films used in agriculture to cover and protect crops, in food packaging and medical applications. The compositions can also be used as containers such as drinks bottles, and for fibre spinning for clothes or other fabric manufacture such as carpets and curtain materials.

In this specification the following test methods have been used:

### 1) Particle Size Measurement of Primary Titanium Dioxide Particles

A small amount of titanium dioxide, typically 2 mg, was pressed into approximately 2 drops of an oil, for one or two minutes using the tip of a steel spatula. The resultant suspension was diluted with solvent and a carbon-coated grid suitable for transmission electron microscopy was wetted with the suspension and dried on a hot-plate. Approximately 18 cm×21 cm photographs were produced at an appropriate, accurate magnification. Generally about 300-500 crystals were displayed at about 2 diameters spacing. A minimum number of 300 primary particles were sized using a transparent size grid consisting of a row of circles of gradually increasing diameter, representing spherical crystals. Under each circle a series of ellipsoid outlines were drawn representing spheroids of equal volume and gradually increasing eccentricity. The basic method assumes log normal distribution standard deviations in the 1.2-1.6 range (wider crystal size distributions would require many more crystals to be counted, for example of the order of 1000). The suspension method described above has been found to be suitable for producing almost totally dispersed distributions of primary metal oxide particles whilst introducing minimal crystal fracture. Any residual aggregates (or secondary particles) are sufficiently well defined that they, and any small debris, can be ignored, and effectively only primary particles included in the count.

Mean length, mean width and length/width size distributions of the primary titanium dioxide particles can be calculated from the above measurements. Similarly, the median particle volume diameter of the primary particles can also be calculated.

### 2) Crystal Size Measurement of Titanium Dioxide Particles

Crystal size was measured by X-ray diffraction (XRD) line broadening. Diffraction patterns were measured with Cu Kα radiation in a Siemens D5000 diffractometer equipped with a Sol-X energy dispersive detector acting as a monochromator. Programmable slits were used to measure diffraction from a 12 mm length of specimen with a step size of 0.02° and step counting time of 3 sec. The data was analysed by fitting the diffraction pattern between 22 and 48° 2θ with a set of peaks corresponding to the reflection positions for rutile and, where anatase was present, an additional set of peaks corresponding to those reflections. The fitting process allowed for removal of the effects of instrument broadening on the diffraction line shapes. The value of the weight average mean crystal size was determined for the rutile 110 reflection (at approximately 27.4° 2θ) based on its integral breadth according to the principles of the method of Stokes and Wilson (B. E. Warren, “X-Ray Diffraction”, Addison-Wesley, Reading, Mass., 1969, pp 254-257).

### 3) Median Particle Volume Diameter and Particle Size Distribution of Titanium Dioxide Particles in Dispersion

A dispersion was produced by mixing 7.2 g of polyhydroxystearic acid with 47.8 g of caprylic/capric triglyceride, and then adding 45 g of titanium dioxide powder into the mixture. The mixture was passed through a horizontal bead mill, operating at 1500 r.p.m. and containing zirconia beads as grinding media for 15 minutes. The dispersion of titanium dioxide particles was diluted to between 30 and 40 g/l by mixing with isopropyl myristate. The diluted sample was analysed on the Brookhaven BI-XDC particle sizer in centrifugation mode, and the median particle volume diameter and particle size distribution measured.

### 4) BET Specific Surface Area of Titanium Dioxide Particles

The single point BET specific surface area was measured using a Micromeritics Flowsorb II 2300.

### 5) Change in Whiteness and Whiteness Index

A titanium dioxide dispersion, e.g. produced in 3) above, was coated on to the surface of a glossy black card and drawn down using a No 2 K bar to form a film of 12 microns wet thickness. The film was allowed to dry at room temperature for 10 minutes and the whiteness of the coating on the black surface (L_{F}) measured using a Minolta CR300 colourimeter. The change in whiteness ΔL was calculated by subtracting the whiteness of the substrate (L_{S}) from the whiteness of the coating (L_{F}). The whiteness index is the percentage whiteness ΔL compared to a standard titanium dioxide (=100% value) (Tayca MT100T (ex Tayca Corporation)).

### 6) Determination of Transmittance, Haze and Clarity

Transmittance, haze and clarity of the, preferably 65 μm thick, polymeric film were measured using a Byk Haze-gard PLUS meter (Cat. No. 4725). Transmittance is defined as the ratio of total transmitted light to incident light. Clarity is defined as narrow angle scattering. More specifically, clarity is the percentage of transmitted light that deviates from the incident by less than 2.5 degrees on average. Haze is defined as wide angle scattering. More specifically, haze is the percentage of transmitted light that deviates from the incident by greater than 2.5 degrees.

7) Photogreying Index

A titanium dioxide dispersion was prepared by milling 15 g of titanium dioxide powder into 85 g of C12-15 alkyl benzoate for 15 min. at 5000 rpm with a mini-motor mill (Eiger Torrance MK M50 VSE TFV), 70% filled with 0.8-1.25 mm zirconia beads (ER120SWIDE). Freshly milled dispersions were loaded into a 16 mm diameter×3 mm deep recess in 65×30×6 mm acrylic cells. A quartz glass cover slip was placed over the sample to eliminate contact with the atmosphere, and secured in place by a brass catch. Up to 12 cells could be placed on a rotating platform, positioned 12 cm from a 75 W UV light source (Philips HB 171/A with 4 TL29D16/09N lamps) and irradiated for 120 minutes. Sample colour (L*a*b* value) was recorded by a commercial colour meter (Minolta chroma meter CR-300), previously calibrated with a standard white tile (L*=97.95). The change in whiteness ΔL* was calculated by subtracting the whiteness of the substrate before exposure to UV light (L*ᵢₙᵢₜᵢₐₗ) from the whiteness of the substrate after exposure to UV light. The photogreying index ΔL*=L*₍ᵢₙᵢₜᵢₐₗ₎−L*₍₁₂₀ₘᵢₙ₎.

### 8) Extinction Coefficients

### (a) Titanium Dioxide Particles in Dispersion

0.1 g sample of a titanium dioxide disperson, e.g. produced in 3) above, was diluted with 100 ml of cyclohexane. This diluted sample was then further diluted with cyclohexane in the ratio sample:cyclohexane of 1:19. The total dilution was 1:20,000. The diluted sample was then placed in a spectrophotometer (Perkin-Elmer Lambda 2 UV/VIS Spectrophotometer) with a 1 cm path length and the absorbance, of UV and visible light measured. Extinction coefficients were calculated from the equation A=E.c.l, where A=absorbance, E=extinction coefficient in litres per gram per cm, c=concentration of titanium dioxide particles in grams per litre, and I=path length in cm.

### (b) Masterbatch Composition and UV Absorbing Polymeric Composition

A 1×5 cm section of 65 μm film, e.g. formed using a titanium dioxide masterbatch composition (produced as described in the Examples) was placed in a spectrophotometer (Perkin-Elmer Lambda 2 UV/VIS Spectrophotometer), previously calibrated with a blank or control film not containing titanium dioxide particles, and held in place by a specially designed sample holder. Absorbance measurements were taken at 10 random positions on the film sample, and mean extinction coefficient values calculated.

The invention is illustrated by the following non-limiting examples.

### EXAMPLES

### Example 1

2 moles of titanium oxydichloride in acidic solution were reacted with 6 moles of NaOH in aqueous solution, with stirring, in a 3 litre glass vessel. After the initial reaction phase, the temperature was increased to above 70° C., by heating at a rate of approximately 1° C./min, and stirring continued for at least another 60 minutes. The mixture was then neutralised by the addition of NaOH in aqueous solution, and allowed to cool below 70° C.

To the resultant dispersion, an alkaline solution of sodium aluminate was added, equivalent to 10.5% by weight Al₂O₃ on TIO₂ weight. The temperature was maintained below 70° C. during the addition. The temperature was then increased to above 70° C., and stirred for at least another 10 minutes. Sodium stearate equivalent to 13.5% by weight stearate on weight of TiO₂ was added, and the reaction mixture again stirred for at least a further 10 minutes.

The dispersion was neutralised to pH 6.5 to 7.0 by adding hydrochloric acid solution over 30 minutes. The neutralised slurry was aged for 15 minutes whilst being stirred. The slurry was then filtered to produce a filter cake which was then washed repeatedly with demineralised water until the cake conductivity (when a small sample was reslurried to 100 g/l) was less than 500 μs. The filter cake was dried in an oven at 105° C. for 16 hours and then micropulverised using a hammer mill to produce particulate titanium dioxide.

A dispersion was produced by mixing 7.2 g of polyhydroxystearic acid with 47.8 g of caprylic/capric triglyceride, and then adding 45 g of pre-dried coated titanium dioxide powder produced above into the mixture. The mixture was passed through a horizontal bead mill, operating at 1500 r.p.m. and containing zirconia beads as grinding media for 15 minutes.

The dispersion was subjected to the test procedures described herein, and the titanium dioxide exhibited the following extinction coefficient values:

| E₅₂₄ | E₄₅₀ | E₃₀₈ | E₃₆₀ | E (max) | λ (max) | E₃₀₈/E₅₂₄ |
|---|---|---|---|---|---|---|
| 0.9 | 1.4 | 46 | 7.2 | 60 | 280 | 51.1 |

### Example 2

The titanium dioxide dispersion produced in Example 1 was used to prepare an ethylene vinyl actetate (EVA) masterbatch composition. 308 g EVA (Evatene 2020, ex Arkema (MFI=20, vinyl acetate content=20%)) was combined with 132 g titanium dioxide dispersion in a plastic sack, followed by agitation (by hand) to give a homogenous mixture. This mixture was then added to a Thermo Prism 16 mm twin screw extruder operated in the temperature range of 85 to 100° C. (feed zone 85° C., compression zone 90° C., metering zone 100° C.). The extruded masterbatch was continuously produced at a rate of 3 kg per hour, and the 16 mm diameter masterbatch extrudate was immediately cooled in a water trough at a temperature of 6 to 10° C. A screw torque value of 35 to 40% was maintained throughout extrusion. The extruded masterbatch sample was then processed (chopped up) further to reduce the average extrudate length to around 5 mm. The resulting pellets were collected and placed In a drying oven for 30 minutes at approximately 40° C. This gave a final masterbatch sample of composition 70% EVA and 30% titanium dioxide dispersion (12% TiO₂).

### Example 3

The procedure of Example 2 was repeated except that low density polyethylene (LDPE) (Exxon PLX6101RQP, MFI=26) was used instead of EVA. The only change in the process conditions was that the Thermo Prism 16 mm twin screw extruder was operated in the temperature range of 105 to 125° C. (feed zone 105° C., compression zone 115° C., metering zone 125° C.).

### Example 4

The masterbatch composition produced in Example 2 was used to make a LDPE blown film sample of 65 μm thickness.

To prepare the film, a homogenous let down mixture of 25 g of the masterbatch composition prepared in Example 2 and 975 g of LDPE (Exxon LD165BW1) was hand blended in a plastic sack. The intimate mixture was then added into a Secor 25 mm single screw extruder fitted with three phase pre-die heating (B1, B2 and B3, with B1 closest to the film die), and three phase die heating (Die 1, Die 2 and Die 3) with adjustable film die 50 mm outside diameter and 49.5 mm internal diameter. Processing was carried out using the conditions given below to give a blown polyethylene film of 65 microns thickness. The film was collected via a conventional film tower with collapsing boards and nip rolls. The film samples were collected on cardboard spools by hand and immediately stored in polythene bags, to avoid static dust contamination. Extrusion temperatures and screw speed were kept constant.

### Processing Conditions

Screw Extruder

| | |
|---|---|
| B1 | 169° C. |
| B2 | 180° C. |
| B3 | 190° C. |
| Die 1 | 190° C. |
| Die 2 | 191° C. |
| Die 3 | 185° C. |
| Polymer residence | 5 mins |
| Screw rpm | 36 |
| Motor Current | 13 A |
| Output rate | 3.42 m/min |
| Output rate | 52 g/min |

### Physical Characteristics of Film

| | |
|---|---|
| Single film | 65 microns |
| Film width | 130 mm |

### Example 5

The procedure of Example 4 was repeated except that 25 g of the masterbatch composition produced in Example 3 was used instead to make a LDPE blown film sample of 65 μm thickness.

### Example 6

As a comparative example, the procedure of Example 4 was repeated except that 1000 g of LDPE (Exxon LD165BW1) was used with no masterbatch composition to make a LDPE blown film sample of 65 μm thickness.

The films were subjected to the test procedures described herein, and exhibited the following properties:

| | E₅₂₄ | E₃₀₈ | E₃₆₀ | E (max) | λ (max) | E₃₀₈/E₅₂₄ |
|---|---|---|---|---|---|---|
| Example 4 | 0.7 | 32.5 | 5.7 | 40.8 | 278 | 46.6 |
| Example 5 | 1.2 | 37.0 | 10.2 | 40.8 | 284 | 30.8 |

| | | | Example 6 |
|---|---|---|---|
| | Example 4 | Example 5 | (Comparative) |
| Transmittance | 92.2 | 90.5 | 92.7 |
| Haze | 40.9 | 42.5 | 40.2 |
| Clarity | 30.8 | 30.6 | 32.0 |

The above examples illustrate the improved properties of a masterbatch and UV absorbing polymeric composition according to the present invention.

1. A UV absorbing polymeric composition having an E₃₀₈/E₅₂₄ ratio of greater than 10 which comprises an organic resin and titanium dioxide particles.

2. A composition according to claim 1 having an extinction coefficient at 524 nm (E₅₂₄) of less than 2.0 l/g/cm.

3. A composition according to claim 1 having an extinction coefficient at 308 nm (E₃₀₈) of greater than 20 l/g/cm.

4. A composition according to claim 1 having an E₃₀₈/E₅₂₄ ratio of greater than 20.

5. A composition according to claim 1 having an E₃₀₈/E₅₂₄ ratio at least 55% of the original value for the titanium dioxide particles.

6. A composition according to claim 1 comprising (i) 60 to 99.9% by weight of organic resin; (ii) 0.05 to 20% by weight of organic dispersing medium; and (iii) 0.05 to 20% by weight of titanium dioxide particles.

7. A composition according to claim 6 wherein the dispersing medium is selected from the group consisting of glycerol esters, glycerol ethers, glycol esters, glycerol ethers, alkyl amides, alkanolamines, and mixtures thereof.

8. A composition according to claim 1 wherein the titanium dioxide has a median volume particle diameter in dispersion of 24 to 50 nm.

9. A masterbatch composition comprising an organic resin, an organic dispersing medium and titanium dioxide particles.

10. A masterbatch according to claim 9 wherein the organic resin has a melting point of 75 to 400° C.

11. A masterbatch according to claim 9 wherein the organic dispersing medium is selected from the group consisting of glycerol monostearate, glycerol monoisostearate, diethanolamine, stearamide, oleamide, erucamide, behenamide, ethylene bis-stearamide, ethylene bis-isostearamide polyglycerol stearate, polyglycerol isostearate, polyglycol ether, triglyceride, and mixtures thereof.

12. A masterbatch according to claim 9 formed from titanium dioxide particles having an E₃₀₈/E₅₂₄ ratio of greater than 20.

13. A masterbatch according to claim 9 having an extinction coefficient at 524 nm (E₅₂₄) of less than 2.0 l/g/cm and/or an extinction coefficient at 308 nm (E₃₀₈) of greater than 20 l/g/cm.

14. A masterbatch according to claim 9 having an E₃₀₈/E₅₂₄ ratio of greater than 20.

15. A masterbatch according to claim 9 having an E₃₀₈/E₅₂₄ ratio at least 55% of the original value for the titanium dioxide particles.

16. A method of producing a masterbatch composition as defined in claim 9 which comprises mixing a dispersion of titanium dioxide particles in an organic dispersing medium, with an organic resin.

17. A method of producing a UV absorbing polymeric composition as defined in claim 1 comprising the steps of providing (i) a masterbatch composition as defined in any one of claims 9 to 15, and mixing the masterbatch composition with a substrate organic resin, or (ii) a dispersion of titanium dioxide particles in an organic dispersing medium, and incorporating the dispersion directly into a substrate organic resin.
